(19) United States
(12) Patent Application Publication
(10) Pub. No.: US 2025/0179330 A1
(43) Pub. Date: Jun. 5, 2025

(54) ONE-COMPONENT POLYURETHANE SEALANT COMPOSITION, ARTICLE THEREOF AND METHOD FOR MANUFACTURING THE SAME

(71) Applicant: Henkel AG & Co. KGaA, Düsseldorf (DE)

(72) Inventors: YaLong Qi, Shanghai (CN); HongYu Chu, Shanghai (CN)

(21) Appl. No.: 19/037,539

(22) Filed: Jan. 27, 2025

Related U.S. Application Data
(63) Continuation of application No. PCT/CN2022/108579, filed on Jul. 28, 2022.

(51) Int. Cl. C09D 175/08; C08G 18/12; C08G 18/24; C08K 3/26; C08K 5/43; C08K 5/5465; C09D 7/61; C09D 7/63

(52) U.S. Cl. CPC C09D 175/08; C08G 18/12; C08G 18/244; C09D 7/61; C09D 7/63; C08K 2003/265; C08K 5/43; C08K 5/5465; C08K 2201/014

(57) ABSTRACT

The invention relates to a one-component moisture-curable polyurethane sealant composition comprises an isocyanate terminated polyurethane prepolymer, NCO group content of the isocyanate-terminated polyurethane prepolymer being 1.8-4.0 wt. %, based on the total weight of the isocyanate terminated polyurethane prepolymer, an effective amount of crosslinker, the functionality of the crosslinker being 3, an effective amount of catalyst, and a silane coupling agent, the mole ratio of the silane coupling agent to the NCO group of the isocyanate terminated polyurethane prepolymer being 40:100 to 120:100.

### TECHNICAL FIELD

The present invention relates to one-component (1K) polyurethane sealant compositions and to the use thereof. More particularly, one-component (1K) moisture-curable polyurethane sealant compositions and the use as sealant, a method for manufacturing the same, and an article comprising the cured one-component (1K) moisture-curable polyurethane sealant composition as sealant.

### BACKGROUND OF THE INVENTION

Polyurethane sealant compositions typically comprise at least one urethane prepolymer. Such polyurethane sealants are often prepared to have terminal isocyanate groups. On exposure to atmospheric moisture, the isocyanate groups react with water to form amino groups with the evolution of carbon dioxide. The amino groups so formed further react with available isocyanate groups to form urea linkages, thus effecting a cure of the polymer in the sealant and binding the materials to be adhered. Sealants are useful for bonding to non-porous substrates, such as glass, ceramic and metal.

The moisture-curable polyurethane sealant system is well known to have several advantages. However, when such sealants were used to bond inorganic substrates, especially to bond metal substrates, the sealant always fails adhesion after water fog aging.

### SUMMARY OF THE INVENTION

The present invention provides one-component (1K) moisture-curable polyurethane sealant compositions which can be used as sealant on metal substrates, especially on steel metal or tin substrates, with improved adhesion property, anti-corrosion property and anti-water fog aging property. The polyurethane sealant of present invention could be cured at room temperature and has no hazardous solvent and low VOC emission. It provides an efficient method for bonding a polyurethane sealant to an inorganic surface (steel metal or tin) without pre-treatment.

In one aspect of the invention, the one-component moisture-curable polyurethane sealant composition comprises: an isocyanate terminated polyurethane prepolymer, NCO group content of the isocyanate-terminated polyurethane prepolymer being 1.8-4.0 wt. %, based on the total weight of the isocyanate terminated polyurethane prepolymer, an effective amount of crosslinker, the functionality of the crosslinker being 3, an effective amount of catalyst, and a silane coupling agent, the mole ratio of the —Si—O-A group of the silane coupling agent to the NCO group of the isocyanate terminated polyurethane prepolymer being 40:100 to 120:100, the silane coupling agent being represented by the following formulas:

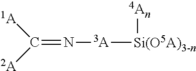

a.
wherein, independently,
¹A, ²A, may being the same or different, and each being C1-C10, linear or branched, aliphatic or alicyclic or substituted alicyclic or aromatic hydrocarbons,
³A being a linear or branched, aliphatic or alicyclic or substituted alicyclic or aromatic divalent hydrocarbon residue having 1 to 20 carbon atoms,
⁴A, ⁵A, may being the same or different, and each representing a linear or branched alkyl group having 1 to 5 carbon atoms,
n being an integer of 0 to 2.

In another aspect, the present invention provides an article includes a sealant on a surface of the article, wherein the sealant is a cured product of the composition of present invention.

In still another aspect, the present invention provides a method of sealing a substrate, the method including applying the one-component moisture-curable polyurethane sealant composition of the present invention to at least a surface of an article and then curing the one-component moisture-curable polyurethane sealant composition on the surface.

Further objects and advantages of this invention will be apparent from the following detailed description and examples of a presently preferred embodiment.

### DETAILED DESCRIPTION OF THE INVENTION

In the following passages the present invention is described in more detail. Each aspect so described may be combined with any other aspect or aspects unless clearly indicated to the contrary. In particularly, any feature indicated as being preferred or advantageous may be combined with any other feature or features indicated as being preferred or advantageous.

In the context of the present invention, the terms used are to be construed in accordance with the following definitions, unless a context dictates otherwise.

As used herein, the singular forms “a”, “an” and “the” include both singular and plural referents unless the context clearly dictates otherwise. As used in this specification and the appended claims, the term “or” is generally employed in its sense including “and/or” unless the content clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or process steps.

Unless specified otherwise, the recitation of numerical end points includes all numbers and fractions subsumed within the respective ranges, as well as the recited end points.

All percentages given herein in relation to the compositions or formulations relate to weight % relative to the total weight of the respective composition or formula, if not explicitly stated otherwise.

Unless otherwise defined, all terms used in the disclosing the invention, including technical and scientific terms, have the meaning as commonly understood by one of the ordinary skills in the art to which this invention belongs to. By means of further guidance, term definitions are included to better appreciate the teaching of the present invention.

The sealant of the invention is a one-component, moisture-curing material. As used herein, “one-component” means that all ingredients of the sealant (except H₂O which is supplied during moisture-curing process) are formed into a single blended material. The term “moisture-curable” means that the sealant can cure via a mechanism that includes at least in part a reaction of water with one or more components of the sealant. In particular, the moisture cure involves i) a reaction of water with isocyanate groups of the prepolymer, ii) a reaction of water with the silane coupling agent to generate amino groups that further catalyze the reaction of water with isocyanate groups of the prepolymer, iii) both i and ii, and ii being preferentially encouraged, or iv), ii then i.

As used herein, “Mw” refers to the weight average molecular weight and means the theoretical value as determined by Gel Permeation Chromatography (GPC) relative to linear polystyrene standards of 1.1 M to 580 Da and may be performed using Waters 2695 separation module with a Waters 2414 differential refractometer (RI detector). “Mn” refers to the number average molecular weight and means the theoretical value as determined by Gel Permeation Chromatography (GPC) too.

As used herein, the glass transition temperature (Tg) or the melting point of a specific polymer is determined using DSC according to DIN 53 765.

The term “NCO content” refers to the content of isocyanate groups in % by weight.

The term “cure” refers to exposing to radiation in any form, heating, or allowing to undergo a physical or chemical reaction that results in hardening or an increase in viscosity.

It was surprisingly found that the object of present invention is solved by a polyurethane sealant composition comprising a cured product which is obtained from a one-component (1K) moisture-curable polyurethane sealant composition. The one-component (1K) moisture-curable polyurethane sealant composition comprises an isocyanate terminated polyurethane prepolymer, an effective amount of crosslinker, an effective amount of catalyst, and a special silane coupling agent, the mole ratio of the silane coupling agent to the isocyanate terminated polyurethane prepolymer being in a certain range.

### Isocyanate Terminated Polyurethane Prepolymer

The isocyanate terminated polyurethane prepolymer of the invention is obtained from the reaction of at least one monomeric aromatic diisocyanate and a polyol having an average OH functionality in the range from 2 to 3 and an OH number in the range from 20 to 100 mg KOH/g. The NCO content of the isocyanate terminated polyurethane prepolymer is in the range from 1.8% to 4.0% by weight, or 2.0% to 4.0% by weight, or 2.0% to 3.5% by weight, or 2.5% to 4.0% by weight, or 2.5% to 3.5% by weight.

In this reaction any of the known catalysts can be used such as dibutyltin dilaurate, stannous octoate, triethylenediamine, lead octoate, bis(dimethylamino) ethyl ether, and the like. The catalyst is present at a concentration of from about 0.001% to about 1.0% by weight. The conventional catalytic amounts are employed.

In this reaction, the monomeric aromatic diisocyanate is employed in excess so that the resultant prepolymers have isocyanate terminals.

Preferably, the prepolymer of the invention has an average molecular weight Mn in the range from 5,000 to 15,000 g/mol, determined by means of gel permeation chromatography (GPC) versus polystyrene standard with tetrahydrofuran as mobile phase, refractive index detector and evaluation from 200 g/mol. More preferably, the average molecular weight is in the range from 5500 to 12 000 g/mol, especially in the range from 6000 to 10 000 g/mol.

A suitable monomeric aromatic diisocyanate is especially diphenylmethane 4,4′-diisocyanate, optionally with fractions of diphenylmethane 2,4′- and/or 2,2′-diisocyanate (MDI), tolylene 2,4-diisocyanate or mixtures thereof with tolylene 2,6-diisocyanate (TDI), phenylene 1,4-diisocyanate (PDI), 2,3,5,6-tetramethyl-1,4-diisocyanatobenzene, naphthalene 1,5-diisocyanate (NDI) or 3,3′-dimethyl-4,4′-diisocyanatodiphenyl (TODI). Among these, preference is given to diphenylmethane 4,4′-diisocyanate or tolylene 2,4-diisocyanate or phenylene 1,4-diisocyanate.

A particularly preferred monomeric aromatic diisocyanate is diphenylmethane 4,4′-diisocyanate (4,4′-MDI). This 4,4′-MDI is of a quality that contains only small fractions of diphenylmethane 2,4′- and/or 2,2′-diisocyanate and is solid at room temperature.

A commercially available diphenylmethane 4,4′-diisocyanate of this quality is, for example, Desmodur 44 MC (from Covestro) or Lupranat MRSS oder ME (from BASF) or Suprasec 1400 (from Huntsman).

A suitable polyol is especially polyether polyol. In some embodiments, a certain amount of optional polyester polyol is used together with polyether polyol. Repeat units present in the polyether polyol are preferably 1,2-ethyleneoxy, 1,2-propyleneoxy, 1,3-propyleneoxy, 1,2-butyleneoxy or 1,4-butyleneoxy groups. Preference is given to 1,2-ethyleneoxy and/or 1,2-propyleneoxy groups. More preferably, repeat units present in the polyether polyol are mainly or exclusively 1,2-propyleneoxy groups. More particularly, the polyether polyol, based on all repeat units, has 80% to 100% by weight of 1,2-propyleneoxy groups and 0% to 20% by weight of 1,2-ethyleneoxy groups. Most preferably, the polyether polyol, based on all repeat units, has 80% to 90% by weight of 1,2-propyleneoxy groups and 10% to 20% by weight of 1,2-ethyleneoxy groups. The 1,2-propyleneoxy groups and the 1,2-ethyleneoxy groups here each especially form homogeneous blocks, and the poly(1,2-ethyleneoxy) blocks are at the chain ends.

The polyether polyol preferably has an OH number in the range from 20 to 100 mg KOH/g, based on all repeat units, has 80% to 90% by weight of 1,2-propyleneoxy groups and 10% to 20% by weight of 1,2-ethyleneoxy groups.

The polyether polyol preferably has an average molecular weight Mn in the range from 4,000 to 8,500 g/mol, especially 5,200 to 7,500 g/mol.

Such polyether polyols are commercially available, for example as Caradol ET28-03 (from Shell), Desmophen 5031 BT (from Covestro) or Voranol 5815 (from Dow).

The raw materials of the isocyanate terminated polyurethane prepolymer may further comprise optional polyester polyol. The polyester polyols include lactone polyols prepared by the polymerization of lactones, compounds such as castor oil, and polyester polyols formed by the reaction of an alkylene glycol with a dicarboxylic acid, for example.

In some embodiments of present invention, the one-component polyurethane sealant composition comprises 10 to 60 parts by weight, or 20 to 50 parts by weight, or 30 to 50 parts by weight of isocyanate terminated polyurethane prepolymer.

Such a prepolymer cooperate with other components of present invention enables one-component polyurethane sealant compositions having a particularly attractive combination of low curing temperature, long open time coupled with rapid curing, good adhesion after the aging of water fog, and good corrosion resistance.

### Crosslinker

Crosslinking agents (also called “crosslinker”) suitable in the context of the present invention are known in the art and may include, for instance, compounds that comprise at least three, preferably three NCO-groups. Preferred are modified polyurethane polymers with NCO groups at the termini and, optionally, also within the chain.

Crosslinking agents are substantially free of organic polyamines, such as the primary or secondary diamines or triamines. The polyamines can be any of the known aliphatic or aromatic polyamines such as ethylene diamine, diethylene traimine, propylene diamine, hexamethylene diamine, methylene bis (aniline), tolylene diamine, isophorone diamine, trimethylpetane diamine, aniline-formaldehyde adduct polyamines, and the like. Such organic polyamines have a bad effect on storage stability and other desired properties.

As previously indicated, the suitable crosslinkers are optionally, from 0.5 to 15 wt. %, or from 1 to 15 wt. %, or from 5 to 15 wt. %, based on total weight of the sealant composition, an aliphatic isocyanate crosslinker. The aliphatic isocyanate crosslinker may be an aliphatic diisocyanate such as hexamethylene diisocyanate (HDI); a trimer of such diisocyanate; an aliphatic triisocyanate; and also, a polymer derived from these homopolymerized or copolymerized monomers, or derived from the addition of a polyol or of a polyamine with one or more of these monomers, with the polyol or the polyamine possibly being a polyether, a polyester, a polycarbonate, or a polyacrylate. In some embodiments of present invention, the aliphatic isocyanate crosslinker has an NCO functionality equal to or above 3.

The amount of crosslinking agent used is an amount sufficient to react with all of the terminal isocyanato groups and to affect a light crosslinking. The desired concentration of crosslinker is that wherein the equivalents of reactive crosslinking groups in the crosslinking agent used is equivalent to the number of equivalents of isocyanato groups present in the prepolymer. This amount should be sufficient to react with all of the isocyanato groups and crosslink the polymer, but it should not be an amount which would result in end-capping of the isocyanato groups rather than crosslinking.

### Silane Coupling Agent

The silane coupling agent of present invention can be commercially available or be prepared by known methods.

In some embodiments, the silane coupling agents have a formula as below:

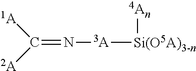

wherein, independently,
¹A, ²A, may being the same or different, and each being C1-C10, linear or branched, aliphatic or alicyclic or substituted alicyclic or aromatic hydrocarbons. Preferably ¹A, ²A being different and each being C1-C6, linear or branched, aliphatic or alicyclic or substituted alicyclic or aromatic hydrocarbon group.
³A being a linear or branched, aliphatic or alicyclic or substituted alicyclic or aromatic divalent hydrocarbon residue having 1 to 20 carbon atoms, preferably having 2 to 6 carbon atoms, more preferably ³A being —CH₂—CH₂— or —CH₂—CH₂—CH₂—.
⁴A, ⁵A, may being the same or different, and each representing a linear or branched alkyl group having 1 to 5 carbon atoms, preferably having 1 to 3 carbon atoms, more preferably ⁴A, ⁵A, each representing methyl, ethyl or isopropyl;
n being an integer of 0 to 2.

In some embodiments of present invention, the silane coupling agents include ((Triethoxysilyl)propyl)methylisobutylimine, ((Trimethoxysilyl)propyl)methylisobutylimine, ((methyl dimethoxysilyl)propyl)methylisobutylimine and the like. In some embodiments of present invention, the mole ratio of the —Si—O-A group of the silane coupling agent to the NCO group of the isocyanate terminated polyurethane prepolymer being 40:100 to 120:100, preferably being 42:100 to 108:100. When the contents of the silane coupling agent and isocyanate terminated polyurethane prepolymer are in above range, the sealant have good anti water fog property.

In some preferred embodiments, the content of silane coupling agents also impact the degree of crosslinking. Moisture/water reacts preferentially with the silane coupling agents of present invention rather than reacting with NCO groups. Overdosed silane coupling agent produce an access amount of primary amine group containing silane coupling agents, the primary amine groups promote or accelerate the curing reaction, then impact the crosslinking reaction. Thus, the crosslinking degree of the sealant decreases, meanwhile the strength of the sealant is affected.

“Alkyl”, as used in the context of the present invention, relates to a linear or branched hydrocarbon group having 1 to 20 carbon atoms. As non-limiting examples thereof, methyl, ethyl, propyl, isopropyl, tert-butyl, n-pentyl, and isopentyl may be mentioned.

Such silane coupling agents are commercially available, for example, KBE 9103 P from Shin-Etsu Chemical Co., Ltd., S340 from Chisso Corporation, Dynasylan VPS 1262 from Evonik.

### Catalyst

The one-component polyurethane sealant composition optionally comprises a catalyst.

Suitable catalysts are catalysts for the acceleration of the reaction of isocyanate groups and hydroxyl groups, especially organotin(IV) compounds such as, in particular, dibutyltin diacetate, dibutyltin dilaurate, dibutyltin dichloride, dibutyltin diacetylacetonate, dimethyltin dilaurate, dioctyltin diacetate, dioctyltin dilaurate or dioctyltin diacetylacetonate, complexes of bismuth(III) or zirconium(IV), especially with ligands selected from alkoxides, carboxylates, 1,3-diketonates, oxinate, 1,3-ketoesterates and 1,3-ketoamidates, or compounds containing tertiary amino groups, such as especially 2,2′-dimorpholinodiethyl ether (DMDEE).

It is possible to use commercially available products in the present invention. Examples thereof include Dabco T 12, which is available from Evonik Specialty Chemicals (Shanghai).

With particular preference, the catalyst may be incorporated into the one-component polyurethane sealant composition in an amount of from 0.1 to 0.5% by weight, preferably in an amount of from 0.15% to 0.3%, such as 0.15%, 0.25%, 0.3% by weight, based on the total amount of the composition.

### Other Compounds

For formulating sealant compositions, the sealant compositions of the invention are combined with fillers and additives known in the prior art for use in sealant compositions. By the addition of such fillers/additives, physical properties such as rheological properties, viscosity, flow rate, sag, and the like can be modified to desired values. However, to prevent premature hydrolysis of the moisture sensitive groups of the polymer, such filler/additives should be thoroughly dried before admixture therewith.

The polyurethane sealant composition of the present invention may contain, if necessary, various additives, in a range that does not inhibit the object of the present technology, such as fillers, plasticizers, antiaging agents, antioxidants, pigments (dyes), thixotropic agents, ultraviolet absorbers, flame retardants, surfactants (including leveling agents), dispersing agents, dehydrating agents, adhesion promoters, and antistatic agents.

### <Filler>

Examples of the fillers include organic or inorganic fillers of any form. Specific examples include hollow glass bubbles, fumed silica, calcined silica, precipitated silica, pulverized silica, molten silica; diatomaceous earth; iron oxide, zinc oxide, titanium oxide, barium oxide, magnesium oxide; calcium carbonate, heavy calcium carbonate, precipitated calcium carbonate (light calcium carbonate), colloidal calcium carbonate, magnesium carbonate, zinc carbonate; pyrophyllite clay, kaolin clay, calcined clay; fatty acid treated products, resin acid treated products, urethane compound treated products, PVC powder, and fatty acid ester treated products thereof; and the like. One type of these may be used alone, or two or more types of these may be used in combination.

### <Plasticizer>

Suitable plasticizers are well-known in the art and include alkyl phthalates such as dioctyl phthalate or dibutyl phthalate, partially hydrogenated terpene commercially available as “HB-40”, and alkyl naphthalenes.

Specific examples of the plasticizer include diisononyl phthalate (DINP); dioctyl adipate, isodecyl succinate; diethylene glycol dibenzoate, pentaerythritol ester; butyl oleate, methyl acetyl ricinoleate; tricresyl phosphate, trioctyl phosphate; propylene glycol adipate polyester, butylene glycol adipate polyester, and the like. One type of these may be used alone, or two or more types of these may be used in combination.

### <Pigment>

Specific examples of the pigment include inorganic pigments such as titanium oxide, zinc oxide, ultramarine, iron red, lithopone, lead, cadmium, iron, cobalt, aluminum, hydrochlorides, and sulfates; and organic pigments such as azo pigments, phthalocyanine pigments, quinacridone pigments, quinacridonequinone pigments, dioxazine pigments, anthrapyrimidine pigments, anthanthrone pigments, indanthrone pigments, flavanthrone pigments, perylene pigments, perinone pigments, diketopyrrolopyrrole pigments, quinonaphthalone pigments, anthraquinone pigments, thioindigo pigments, benzimidazolone pigments, isoindoline pigment, and carbon black; and the like.

Commercially available pigments include carbon blacks, such as titanium dioxides such as those available from Multibis.

### <Water Remover>

Water removers are well-known in the art and include toluenesulfonyl isocyanate and other reactive isocyanates, molecular sieves, calcium oxide, procarbonate, silicate, etc. Oxazolides, imines and other water removers have a negative impact on the storage of one-component polyurethane composition because they react with water to form amine compounds.

With particular preference, the water remover may be incorporated into the one-component polyurethane sealant composition in an amount of from 0.05 to 4.0% by weight, based on the total amount of the polyurethane composition.

The one-component polyurethane sealant composition according to the present invention may optionally comprise one or more further compounds, such as plasticizer, fillers, water remover, which can be combined upon necessary.

### Preparing Method of the Polyurethane Sealant Compositions

A composition referred to as a “one-component” composition is one in which all constituents of the composition are in the same container, and which is storage-stable per se. The moisture-curing polyurethane composition is preferably a one-component composition. Given suitable packaging and storage, it is storage-stable, typically over several months, up to one year or longer.

On application of the moisture-curable polyurethane sealant composition, the process of curing commences. This results in the cured sealant composition.

The invention further provides a method of sealing, comprising the steps of:
1) applying the one-component moisture-curable polyurethane sealant composition of present invention to a first substrate,
2) optionally contacting the composition with a second substrate within the open time of the composition,
3) curing the composition by contacting with moisture.

The sealant compositions can be applied to the substrate(s) by all known techniques. Before applying the one-component moisture-curable polyurethane sealant composition of present invention to substrate(s), no extra pre-treatment to the surface of the substrate(s), such as, applying primer coating on the surface, is needed.

The moisture required for the curing of the moisture-curable polyurethane sealant composition preferably gets into the composition through diffusion from the air (atmospheric moisture). In the process, a solid layer of cured composition is formed on the surfaces of the composition which come into contact with air (“skin”). The curing continues in the direction of diffusion from the outside inward, the skin becoming increasingly thick and ultimately encompassing the entire composition applied. The moisture on one or more substrate(s) preferentially react with the silane coupling agent of present invention and produce ketones and amines. The ketones are basically nonvolatile at operating temperature/curing temperature; thus, the ketones will remain for the most part in the cured sealant composition to reduce the viscosity of the composition, to improve wettability of the plastic substrate, and to strengthen the adhesion. At operating temperature/curing temperature higher than the boiling point of the ketones, a good adhesion can be achieved on the metallic substrate.

The moisture-curable polyurethane sealant composition is preferably applied at ambient temperature, especially in the range from about −10 to 50° C., preferably in the range from −5 to 45° C., especially 0 to 40° C.

The moisture-curable polyurethane sealant composition is preferably likewise cured at ambient temperature.

The substrates are preferably inorganic substrates including glass, ceramics, metals, etc. Metal includes carbon steel, galvanized steel, stainless steel, tin plate. The substrates of present invention may also include plastic substrates such as polycarbonate; powder coated substrates such as automotive electrophoretic paint treated substrates. Particularly suitable substrates are bare metal.

The “curing rate” refers to the degree of polymer formation in the sealant composition within a given period of time after application, especially by determining the thickness of the skin formed.

The moisture-curing polyurethane composition is especially suitable as sealant for the elastic sealing of all kinds of joins, seams or cavities, especially of joins in construction, such as expansion joins or connection joins between structural components, or of floor joins in civil engineering. A sealant having flexible properties and high cold flexibility is particularly suitable especially for the sealing of expansion joins in built structures.

It is understood that all embodiments disclosed herein in relation to the methods are similarly applicable to the disclosed dispersions, compositions, and uses and vice versa.

### Listing of Embodiments

1. A one-component polyurethane sealant composition comprises:
   a) an isocyanate terminated polyurethane prepolymer, NCO group content of the isocyanate-terminated polyurethane prepolymer being 1.8-4.0 wt. %, based on the total weight of the isocyanate terminated polyurethane prepolymer,
   b) an effective amount of crosslinker, the functionality of the crosslinker being 3,
   c) an effective amount of catalyst, and
   d) a silane coupling agent, the mole ratio of the —Si—O-A group of the silane coupling agent to the NCO group of the isocyanate terminated polyurethane prepolymer being 40:100 to 120:100, the silane coupling agent being represented by the following formulas:

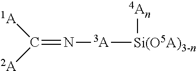

wherein, independently,
   ¹A, ²A, may being the same or different, and each being C1-C10, linear or branched, aliphatic or alicyclic or substituted alicyclic or aromatic hydrocarbons,
      ³A being a linear or branched, aliphatic or alicyclic or substituted alicyclic or aromatic divalent hydrocarbon residue having 1 to 20 carbon atoms,
      ⁴A, ⁵A, may being the same or different, and each representing a linear or branched alkyl group having 1 to 5 carbon atoms,
      n being an integer of 0 to 2.
2. The composition according to embodiment 1, wherein the silane coupling agent being represented by the following formulas:

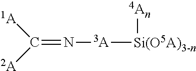

wherein, independently,
   ¹A, ²A each being C1-C6, linear or branched, aliphatic or alicyclic or substituted alicyclic or aromatic hydrocarbon group,
   ³A being a linear aliphatic alkylene having 2 to 6 carbon atoms,
   ⁴A, ⁵A each representing a linear or branched alkyl group having 1 to 3 carbon atoms,
   n being an integer of 0 to 2.
3. The composition according to any one of preceding embodiments, wherein the silane coupling agent being represented by the following formulas:

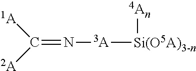

wherein, independently,
   ¹A, ²A each being C1-C6, linear or branched, aliphatic or alicyclic or substituted alicyclic or aromatic hydrocarbons,
   ³A being —CH₂—CH₂— or —CH₂—CH₂—CH₂—,
   ⁴A, ⁵A each representing methyl, ethyl or isopropyl,
   n being an integer of 0 to 1.
4. The composition according to any one of preceding embodiments, wherein the NCO group content of the isocyanate-terminated polyurethane prepolymer is 2.0 to 3.5 wt. %, based on the total weight of the isocyanate terminated polyurethane prepolymer.
5. The composition according to any one of preceding embodiments, wherein the mole ratio of the —Si—O-A group of the silane coupling agent to the NCO group of the isocyanate terminated polyurethane prepolymer being 42:100 to 108:100.
6. The composition according to any one of preceding embodiments, wherein the content of the silane coupling agent is 1.3-2.7 parts by weight.
7. The composition according to any one of preceding embodiments, wherein the content of the silane coupling agent is 1.5-2.5 parts by weight.
8. The composition according to any one of preceding embodiments, wherein the composition comprises 10 to 60 parts by weight of isocyanate terminated polyurethane prepolymer.
9. The composition according to any one of preceding embodiments, wherein the catalyst is selected from a group consisting of platinum, palladium, rhodium, nickel, iridium, ruthenium catalyst, and mixtures thereof.
10. The composition according to any one of preceding embodiments, wherein the composition comprises 0.05 wt. % to 4.0 wt. % of water-remover, based on the total weigh of the composition.
11. The composition according to embodiment 10, wherein the water-remover comprises reactive isocyanate, molecular sieve, calcium oxide, orthoformate, silicate.
12. The composition according to any one of preceding embodiments, wherein the composition comprises 10 to 40 parts by weight of plasticizer.
13. The composition according to any one of preceding embodiments, wherein the composition comprises 10 to 40 parts by weight of filler.
14. The composition according to embodiment 13, wherein the filler comprises calcium carbonate, carbon black, alumina, kaolin, PVC powder, silicate or hollow glass microspheres, mica powder, attapulgite and mixtures thereof.
15. An article includes a sealant on a surface of the article, wherein the sealant is a cured product of the composition of any one of preceding embodiments.
16. A method of using a one-component polyurethane sealant which comprises:
   applying a one-component polyurethane sealant composition of at least one of embodiments 1 to 14 on a surface of an article, and
   curing the one-component polyurethane sealant composition in contact with the surface a to prepare a sealant.

### EXAMPLES

The present invention will be further described and illustrated in detail with reference to the following examples. The examples are intended to assist one skilled in the art to better understand and practice the present invention, however, are not intended to restrict the scope of the present invention. All numbers in the examples are based on weight unless otherwise stated.

### Raw Materials

| Product name | Description/function | Source |
|---|---|---|
| DINP | Diisononyl phthalate, diluent agent, plasticizer. | ExxonMobil China |
| Desmodur 44M liquid | Diphenylmethane-4,4′-diisocyanate | Covestro China |
| CARADOL ET28-03 | polyether polyol, trifunctional, containing | Shell China |
| | hydroxyl groups | |
| Priplast 1838 | Amorphous polyester polyol, functional 2 | Croda China |
| Stannous octoate | catalyst, Tin(2+)2-ethylhexanoate | Sinopharm chemical |
| Mesamoll | diluent agent, plasticizer. C10-21 alkylsulfonic | Lanxess China |
| | acid phenyl ester | |
| Omya-2-QY | Filler, calcium carbonate | Omya China |
| BLH | Filler, calcium carbonate | Omya China |
| Desmodur N 100 | Crosslinker, Hexamethylene diisocyanate | Covestro China |
| | homopolymer | |
| TS 720 | Silica, fumed, adapat the viscosity and provide | Cabot China |
| | thixotropic | |
| Addtive TI | water remover, p-Toluenesulfonyl Isocyanate | Borchers China |
| Dynasylan VPS 1262 | silcane couping agent, | Evonik China |
| | ((Triethoxysilyl)propyl)methylisobutylimine | |
| Dynasylan 1189 | silcane couping agent, N-(n-Butyl)-3- | Evonik China |
| | aminopropyltrimethoxysilane | |
| Silquest 187 | silcane couping | Momentive China |
| | agent, Glycidoxypropyl)trimethoxysilane *3(- | |
| Silquest*A-1170 | silcane couping | Momentive China |
| | agent, Bis(trimethoxysilylpropyl)amine | |

*All raw materials are directly used without any special treatment.

### <Preparation of Isocyanate Terminated Polyurethane Prepolymer>

For the synthesis of P1, Diisononyl phthalate (40 g) and Caradol ET28-03 (354.08 g) were added into a reactor. Then the system was heated to 110° C. under vacuum and stirred for 120 mins. After that, cooled the reactor until the temperature reduced to 80° C., Desmodur 44 M liquid (45.92 g) and Addtive TI (0.64 g) was added into the reactor. Then after stirring for 60 mins under vacuum, the catalyst Stannous octoate (0.008 g) and Diisononyl phthalate (4 g) were charged in and kept stirring for 60 mins under vacuum. Then stopped the heater and cooled the reactor to 40° C. to get the final prepolymer P1.

For the synthesis of P2, Diisononyl phthalate (40 g) and Caradol ET28-03 (359.72 g) were added into a reactor. Then the system was heated to 110° C. under vacuum and stirred for 120 mins. After that, cooled the reactor until the temperature reduced to 80° C., Desmodur 44 M liquid (40.28 g) and Addtive TI (0.64 g) were added into the reactor. Then after stirring for 60 mins under vacuum, the catalyst Stannous octoate (0.008 g) and Diisononyl phthalate (4 g) were charged in and kept stirring for 60 mins under vacuum. Then stopped the heater and cooled the reactor to 40° C. to get the final prepolymer P2.

For the synthesis of P3, Diisononyl phthalate (40 g) and Caradol ET28-03 (365.32 g) were added into a reactor. Then the system was heated to 110° C. under vacuum and stirred for 120 mins. After that, cooled the reactor until the temperature reduced to 80° C., Desmodur 44 M liquid (34.68 g) and Addtive TI (0.64 g) were added into the reactor. Then after stirring for 60 mins under vacuum, the catalyst Stannous octoate (0.008 g) and Diisononyl phthalate (4 g) were charged in and kept stirring for 60 mins under vacuum. Then stopped the heater and cooled the reactor to 40° C. to get the final prepolymer P3.

For the synthesis of P4, Diisononyl phthalate (40 g), Caradol ET28-03 (227.6 g) and Priplast 1838 (113.6 g) were added into a reactor. Then the system was heated to 110° C. under vacuum and stirred for 120 mins. After that, cooled the reactor until the temperature reduced to 80° C., Desmodur 44 M liquid (58.8 g) and Addtive TI (0.64 g) were added into the reactor. Then after stirring for 60 mins under vacuum, the catalyst Stannous octoate (0.008 g) and Diisononyl phthalate (4 g) were charged in and kept stirring for 60 mins under vacuum. Then stopped the heater and cooled the reactor to 40° C. to get the final prepolymer P4.

For the synthesis of P5, Diisononyl phthalate (40 g) and Caradol ET28-03 (361.96 g) were added into a reactor. Then the system was heated to 110° C. under vacuum and stirred for 120 mins. After that, cooled the reactor until the temperature reduced to 80° C., Desmodur 44 M liquid (38.04 g) and Addtive TI (0.64 g) were added into the reactor. Then after stirring for 60 mins under vacuum, the catalyst Stannous octoate (0.008 g) and Diisononyl phthalate (4 g) were charged in and kept stirring for 60 mins under vacuum. Then stopped the heater and cooled the reactor to 40° C. to get the final prepolymer P5.

For the synthesis of P6, Diisononyl phthalate (40 g) and Caradol ET28-03 (337.28 g) were added into a reactor. Then the system was heated to 110° C. under vacuum and stirred for 120 mins. After that, cooled the reactor until the temperature reduced to 80° C., Desmodur 44 M liquid (62.72 g) and Addtive TI (0.64 g) were added into the reactor. Then after stirring for 60 mins under vacuum, the catalyst Stannous octoate (0.008 g) and Diisononyl phthalate (4 g) were charged in and kept stirring for 60 mins under vacuum. Then stopped the heater and cooled the reactor to 40° C. to get the final prepolymer P6.

For the synthesis of P7, Diisononyl phthalate (40 g) and Caradol ET28-03 (331.68 g) were added into a reactor. Then the system was heated to 110° C. under vacuum and stirred for 120 mins. After that, cooled the reactor until the temperature reduced to 80° C., Desmodur 44 M liquid (68.32 g) and Addtive TI (0.64 g) were added into the reactor. Then after stirring for 60 mins under vacuum, the catalyst Stannous octoate (0.008 g) and Diisononyl phthalate (4 g) were charged in and kept stirring for 60 mins under vacuum. Then stopped the heater and cooled the reactor to 40° C. to get the final prepolymer P7.

For the synthesis of P8, Diisononyl phthalate (40 g) and Caradol ET28-03 (326.08 g) were added into a reactor. Then the system was heated to 110° C. under vacuum and stirred for 120 mins. After that, cooled the reactor until the temperature reduced to 80° C., Desmodur 44 M liquid (73.92 g) and Addtive TI (0.64 g) were added into the reactor. Then after stirring for 60 mins under vacuum, the catalyst Stannous octoate (0.008 g) and Diisononyl phthalate (4 g) were charged in and kept stirring for 60 mins under vacuum. Then stopped the heater and cooled the reactor to 40° C. to get the final prepolymer P8.

For the synthesis of P9, Diisononyl phthalate (40 g) and Caradol ET28-03 (313.6 g) were added into a reactor. Then the system was heated to 110° C. under vacuum and stirred for 120 mins. After that, cooled the reactor until the temperature reduced to 80° C., Desmodur 44 M liquid (46 g) and Addtive TI (0.64 g) were added into the reactor. Then after stirring for 60 mins under vacuum, the catalyst Stannous octoate (0.008 g) and Diisononyl phthalate (4 g) were charged in and kept stirring for 60 mins under vacuum. Then stopped the heater and cooled the reactor to 40° C. to get the final prepolymer P9.

### <Preparation of One-Component Polyurethane Sealant Composition>

### Example 1

For the preparation of curable one-component polyurethane sealant composition E1, Mesamoll (14 g), Omya-2-QY (20 g), BLH (10 g), P1 (40 g), Desmodur N 100 (1.25 g) and Addtive TI (0.082 g) were added into a container and mixed by Speedmixer for 1 min at 1000 rpm. Then, TS 720 (2 g) was added into the system and mixed by Speedmixer for 1 min at 1000 rpm, later charged the Dynasylan VPS 1262 (2 g) and mixed by Speedmixer for 30s at 1000 rpm and 60s at 1750 rpm, vacuum was needed during mixing.

### Example 2

For the preparation of curable one-component polyurethane sealant composition E2, Mesamoll (14 g), Omya-2-QY (20 g), BLH (10 g), P9 (40 g), Desmodur N 100 (1.25 g) and Addtive TI (0.082 g) were added into a container and mixed by Speedmixer for 1 min at 1000 rpm. Then, TS 720 (2 g) was added into the system and mixed by Speedmixer for 1 min at 1000 rpm, later charged the Dynasylan VPS 1262 (2 g) and mixed by Speedmixer for 30s at 1000 rpm and 60s at 1750 rpm, vacuum was needed during mixing.

### Example 3

For the preparation of curable one-component polyurethane sealant composition E3, Mesamoll (14 g), Omya-2-QY (20 g), BLH (10 g), P4 (40 g), Desmodur N 100 (1.25 g) and Addtive TI (0.082 g) were added into a container and mixed by Speedmixer for 1 min at 1000 rpm. Then, TS 720 (2 g) was added into the system and mixed by Speedmixer for 1 min at 1000 rpm, later charged the Dynasylan VPS 1262 (2 g) and mixed by Speedmixer for 30s at 1000 rpm and 60s at 1750 rpm, vacuum was needed during mixing.

### Example 4

For the preparation of curable one-component polyurethane sealant composition E4, Mesamoll (14 g), Omya-2-QY (20 g), BLH (10 g), P6 (40 g), Desmodur N 100 (1.25 g) and Addtive TI (0.082 g) were added into a container and mixed by Speedmixer for 1 min at 1000 rpm. Then, TS 720 (2 g) was added into the system and mixed by Speedmixer for 1 min at 1000 rpm, later charged the Dynasylan VPS 1262 (2 g) and mixed by Speedmixer for 30s at 1000 rpm and 60s at 1750 rpm, vacuum was needed during mixing.

### Example 5

For the preparation of curable one-component polyurethane sealant composition E5, Mesamoll (14 g), Omya-2-QY (20 g), BLH (10 g), P7 (40 g), Desmodur N 100 (1.25 g) and Addtive TI (0.082 g) were added into a container and mixed by Speedmixer for 1 min at 1000 rpm. Then, TS 720 (2 g) was added into the system and mixed by Speedmixer for 1 min at 1000 rpm, later charged the Dynasylan VPS 1262 (2 g) and mixed by Speedmixer for 30s at 100 0 rpm and 60s at 1750 rpm, vacuum was needed during mixing.

### Comparative Example 1

For the preparation of curable one-component polyurethane sealant composition CE1, Mesamoll (14 g), Omya-2-QY (20 g), BLH (10 g), P3 (40 g), Desmodur N 100 (1.25 g) and Addtive TI (0.082 g) were added into a container and mixed by Speedmixer for 1 min at 1000 rpm. Then, TS 720 (2 g) was added into the system and mixed by Speedmixer for 1 min at 1000 rpm, later charged the Dynasylan VPS 1262 (2 g) and mixed by Speedmixer for 30s at 1000 rpm and 60s at 1750 rpm, vacuum was needed during mixing.

### Comparative Example 2

For the preparation of curable one-component polyurethane sealant composition CE2, Mesamoll (14 g), Omya-2-QY (20 g), BLH (10 g), P5 (40 g), Desmodur N 100 (1.25 g) and Addtive TI (0.082 g) were added into a container and mixed by Speedmixer for 1 min at 1000 rpm. Then, TS 720 (2 g) was added into the system and mixed by Speedmixer for 1 min at 1000 rpm, later charged the Dynasylan VPS 1262 (2 g) and mixed by Speedmixer for 30s at 1000 rpm and 60s at 1750 rpm, vacuum was needed during mixing.

### Comparative Example 3

For the preparation of curable one-component polyurethane sealant composition CE3, Mesamoll (14 g), Omya-2-QY (20 g), BLH (10 g), P2 (40 g), Desmodur N 100 (1.25 g) and Addtive TI (0.082 g) were added into a container and mixed by Speedmixer for 1 min at 1000 rpm. Then, TS 720 (2 g) was added into the system and mixed by Speedmixer for 1 min at 1000 rpm, later charged the Dynasylan VPS 1262 (2 g) and mixed by Speedmixer for 30s at 1000 rpm and 60s at 1750 rpm, vacuum was needed during mixing.

### Comparative Example 4

For the preparation of curable one-component polyurethane sealant composition CE4, Mesamoll (14 g), Omya-2-QY (20 g), BLH (10 g), P8 (40 g), Desmodur N 100 (1.25 g) and Addtive TI (0.082 g) were added into a container and mixed by Speedmixer for 1 min at 1000 rpm. Then, TS 720 (2 g) was added into the system and mixed by Speedmixer for 1 min at 1000 rpm, later charged the Dynasylan VPS 1262 (2 g) and mixed by Speedmixer for 30s at 1000 rpm and 60s at 1750 rpm, vacuum was needed during mixing.

### Example 6-9, and CE4-CE8

The curable one-component polyurethane sealant compositions of E6 to E10, CE4 to CE11 were prepared in reference to Examples 1-4. The curable one-component polyurethane sealant compositions of E6 to E10 and CE4 to CE11 were cured in reference to Examples 1-4. More details are listed in below result part.

### <Curing of Curable One-Component Polyurethane Sealant Composition>

All samples/sealant assemblies were cured at room temperature (25±2° C.) and 50% humidity.

The cured sealant samples were subjected to various of tests.

The following examples are given to illustrate the present invention. Because these examples are given for illustrative purposes only, the invention should not be deemed limited thereto.

### Test Methods

### Specimen Preparation

The substrates (Tin plate, RS 14 steel sheet) were cleaned by ethyl acetate then conditioned in ambient conditions for several minutes to make sure the surface was completely dry. The sealant composition was applied with a diameter of approx. 10 mm by using a round nozzle. Held the nozzle at an angle of approximately 45° and applied the sealant composition until you feel the backstroke of the sealant composition and the nozzle starts to glide slightly above the surface (the nozzle should not scratch or contaminate the substrate surface). Try to obtain a uniform bead of 12-15 mm width and approximately the half of the width as height. The sealant composition was cured under constant temperature and humidity (23° C., 50% relative humidity) about 7 days.

### <Knife Bead Adhesion Test>

The knife bead adhesion test covers the determination of sealants to tin plate substrate and carbon steel substrate.

After curing, the scraping step was performed by cutting a leading edge of the bead to form a loose tab with a length of approximately 25±5 mm to be secured in a gripping toot, such as a vice grip. The loose tab was then gripped by the gripping tool so that the bead is pulled back on itself. While pulling, at every 6±2 mm of the bead, a 45° angle relative to the oily rolled steel test panel was cut with a knife. The test process is shown in the following FIG. 1.

### Evaluation of the Adhesion:

The failure modes of sealants include adhesion failure (AF) and cohesive failure (CF).

Adhesion failure (AF) refers to bond failure at the interface between the sealant and the substrate. Cohesive failure (CF) refers to failure of bonding within the sealant layer.

Compared with the adhesion failure (AF), the cohesive failure (CF) indicates that the bonding is more stable, and the bonding effect is better.

An estimation of the amount of cohesion failure (CF) was reported as an area percentage. Degree of failure, represented in percent (%) of test area per present failure modes. In general, cohesion failure was categorized into three groups.

### Cohesion Rating Scale:

Excellent: 95% to 100%, CF;
Good: 75% to 95%, CF;
Pass: equal to or greater than 70%, CF;
Not Pass: less than 70%, CF.

The composition was deemed to pass the knife bead adhesion test if the cohesion failure was large, i.e., the cohesion failure was equal to or greater than 70%.

### <Cataplasma Storage Test>

Cataplasma storage test is an accelerated aging testing that exposes a cured sealant on a test panel to 70° C. and 100% relative humidity for 7 days, followed by −20° C. for a minimum of 16 hours.

After the Cataplasma storage, implement the knife bead adhesion test and give the adhesion grade as described above.

### <Appearance (Bubble Check)>

Cut the sealant specimen after curing and check the buddle inside of the sealant.

Appearance test results are recorded and ranked as follows:
Not pass: bubble;
Pass: no bubble.

### Results

TABLE 1

| | P1 | P2 | P3 | P4 | P5 | P6 | P7 | P8 | P9 |
|---|---|---|---|---|---|---|---|---|---|
| Diisononyl | 44 | 44 | 44 | 44 | 44 | 44 | 44 | 44 | 44 |
| phthalate | | | | | | | | | |
| Additive | 0.64 | 0.64 | 0.64 | 0.64 | 0.64 | 0.64 | 0.64 | 0.64 | 0.64 |
| TI | | | | | | | | | |
| MDI 4′4′ | 45.92 | 40.28 | 34.68 | 58.8 | 38.04 | 62.72 | 68.32 | 73.92 | 46 |
| 1838 | 0 | 0 | 0 | 113.6 | 0 | 0 | 0 | 0 | 0 |
| Caradol | 354.08 | 359.72 | 365.32 | 227.6 | 361.96 | 337.28 | 331.68 | 326.08 | 313.6 |
| ET28-03 | | | | | | | | | |
| Stannous | 0.008 | 0.008 | 0.008 | 0.008 | 0.008 | 0.008 | 0.008 | 0.008 | 0.008 |
| octoate | | | | | | | | | |
| Total | 444.64 | 444.64 | 444.64 | 444.64 | 444.64 | 444.64 | 444.64 | 444.64 | 404.24 |
| NCO | 2.0% | 1.5% | 1.0% | 2.7% | 1.3% | 3.5% | 4% | 4.5% | 2.5% |
| content | | | | | | | | | |
| wt. % | | | | | | | | | |

Table 1 shows the compositions of different isocyanate terminated polyurethane prepolymers (P1-P9).

TABLE 2

| | CE1 | CE2 | CE3 | E1 | E2 | E3 | E4 | E5 | CE4 |
|---|---|---|---|---|---|---|---|---|---|
| Mesamoll | 14 | 14 | 14 | 14 | 14 | 14 | 14 | 14 | 14 |
| Omya-2- | 20 | 20 | 20 | 20 | 20 | 20 | 20 | 20 | 20 |
| QY | | | | | | | | | |
| BLH | 10 | 10 | 10 | 10 | 10 | 10 | 10 | 10 | 10 |
| P3 (1.0%) | 40 | | | | | | | | |
| P5 (1.3%) | | 40 | | | | | | | |
| P2 (1.5%) | | | 40 | | | | | | |
| P1 (2.0%) | | | | 40 | | | | | |
| P9 (2.5%) | | | | | 40 | | | | |
| P4 (2.7%) | | | | | | 40 | | | |
| P6 (3.5%) | | | | | | | 40 | | |
| P7 (4.0%) | | | | | | | | 40 | |
| P8 (4.5%) | | | | | | | | | 40 |
| DN 100 | 1.25 | 1.25 | 1.25 | 1.25 | 1.25 | 1.25 | 1.25 | 1.25 | 1.25 |
| TS 720 | 2 | 2 | 2 | 2 | 3 | 2 | 2 | 2 | 2 |
| Addtive TI | 0.082 | 0.082 | 0.082 | 0.082 | 0.08 | 0.082 | 0.082 | 0.082 | 0.082 |
| 1262 | 2 | 2 | 2 | 2 | 2 | 2 | 2 | 2 | 2 |
| Total (parts | 89.332 | 89.332 | 89.332 | 89.332 | 90.33 | 89.332 | 89.332 | 89.332 | 89.332 |
| by weight) | | | | | | | | | |

Table 2 shows compositions of the one-component moisture-curable polyurethane sealant compositions E1-E5 and CE1-CE4.

TABLE 3

| | CE1 | CE2 | CE3 | E1 | E2 | E3 | E4 | E5 | CE4 |
|---|---|---|---|---|---|---|---|---|---|
| Tin plate | 100% | 100% | 100% | 100% | 100% | 100% | 100% | 100% | 100% |
| | CF | CF | CF | CF | CF | CF | CF | CF | CF |
| RS14 (Carbon | 100% | 100% | 100% | 100% | 100% | 100% | 100% | 100% | 100% |
| steel plate) | CF | CF | CF | CF | CF | CF | CF | CF | CF |
| Capaslagma Tin | 100% | 100% | 100% | 100% | 100% | 100% | 100% | 100% | 100% |
| plate | CF | CF | CF | CF | CF | CF | CF | CF | CF |
| Capaslagma | 0% | 0% | 20% | 70% | 100% | 100% | 80% | 70% | 10% |
| RS14 | CF | CF | CF | CF | CF | CF | CF | CF | CF |
| Bubble inside | No | No | No | No | No | No | No | Bubble | Bubble |
| | bubble | bubble | bubble | bubble | bubble | bubble | bubble | | |

Table 3 shows testing results of the one-component moisture-curable polyurethane sealant compositions E1-E5 and CE8-CE4.

It can be seen that the polyurethane sealants of E1 to E5 provides good adhesion on steal metal surface and tin surface without any pre-treatment of dewatering from their surfaces. In addition, the polyurethane sealants of E1 to E5 provides good adhesion properties after Cataplasma storage Test.

TABLE 4

| | CE5 | CE6 | E6 | E7 | E8 | E9 | CE7 | CE8 |
|---|---|---|---|---|---|---|---|---|
| Mesamoll | 14 | 14 | 14 | 14 | 14 | 14 | 14 | 14 |
| Omya-2-QY | 20 | 20 | 20 | 20 | 20 | 20 | 20 | 20 |
| BLH | 10 | 10 | 10 | 10 | 10 | 10 | 10 | 10 |
| P9 (NCO 2.5%) | 40 | 40 | 40 | 40 | 40 | 40 | 40 | 40 |
| DN 100 | 1.25 | 1.25 | 1.25 | 1.25 | 1.25 | 1.25 | 1.25 | 1.25 |
| TS 720 | 2 | 2 | 2 | 2 | 2 | 2 | 2 | 2 |
| Addtive TI | 0.082 | 0.082 | 0.082 | 0.082 | 0.082 | 0.082 | 0.082 | 0.082 |
| 1262 | 0 | 1 | 1.3 | 1.5 | 2.5 | 2.7 | 3 | 3.5 |
| Mole ratio of | 0 | 13% | 17% | 20% | 34% | 36% | 40% | 47% |
| 1262:NCO | | | | | | | | |
| Total | 87.332 | 88.332 | 88.632 | 88.832 | 89.832 | 90.032 | 90.332 | 90.832 |
| (parts by weight) | | | | | | | | |

Table 4 shows compositions of the moisture-curable polyurethane sealant compositions E6-E9 and CE5-CE8.

TABLE 5

| | CE5 | CE6 | E6 | E7 | E8 | E9 | CE7 | CE8 |
|---|---|---|---|---|---|---|---|---|
| Shore A | 47 | 45 | 40 | 38 | 18 | 15 | 10 | 10 |
| Tin plate | 0% | 100% | 100% | 100% | 100% | 100% | 100% | 100% |
| | CF | CF | CF | CF | CF | CF | CF | CF |
| RS14 | 0% | 100% | 100% | 100% | 100% | 100% | 100% | 100% |
| (Carbon steel | CF | CF | CF | CF | CF | CF | CF | CF |
| plate) | | | | | | | | |
| Capaslagma Tin | 0% | 100% | 100% | 100% | 100% | 100% | 100% | 100% |
| plate | CF | CF | CF | CF | CF | CF | CF | CF |
| Capaslagma | 0% | 30% | 70% | 100% | 90% | 70% | 50% | 30% |
| RS14 | CF | CF | CF | CF | CF | CF | CF | CF |
| Bubble inside | NO | NO | NO | NO | NO | NO | NO | NO |
| | bubble | bubble | bubble | bubble | bubble | bubble | bubble | bubble |

Table 5 shows testing results of the moisture-curable polyurethane sealant compositions E6-E9 and CE5-CE8.

TABLE 6

| | CE9 | CE10 | CE11 | CE12 | E10 | E11 |
|---|---|---|---|---|---|---|
| Mesamoll | 14.00 | 14.00 | 14.00 | 14.0 | 14.0 | 14.0 |
| Omya-2-QY | 20.00 | 20.00 | 20.00 | 20.0 | 20.0 | 20.0 |
| BLH | 10.00 | 10.00 | 10.00 | 10.0 | 10.0 | 10.0 |
| P9 (NCO 2.5%) | 40.00 | 40.00 | 40.00 | 40.0 | 40.0 | 40.0 |
| DN 100 | 1.00 | 1.00 | 1.25 | 1.25 | 1.00 | 1.25 |
| TS 720 | 3.00 | 3.00 | 3.00 | 3.00 | 3.00 | 3.00 |
| Addtive TI | 0.08 | 0.08 | 0.08 | 0.08 | 0.08 | 0.08 |
| 1262 | 0.00 | 2.00 | 4.00 | | 1.50 | 2.00 |
| 1189 | | | | 2.00 | 0.50 | |
| Silquest 187 | 2.00 | | | | | |
| Silquest*A-1170 | | 2.00 | | | | |
| Total | 90.08 | 92.08 | 92.32 | 90.32 | 90.12 | 90.32 |
| (parts by weight) | | | | | | |

Table 6 shows compositions of the moisture-curable polyurethane sealant composition E10-E11 and CE9-CE12.

TABLE 7

| | CE9 | CE10 | CE11 | CE12 | E10 | E11 |
|---|---|---|---|---|---|---|
| Tin plate | 100% | 100% | 100% | 100% | 100% | 100% |
| | CF | CF | CF | CF | CF | CF |
| RS14 (Carbon | 0% | 0% | 100% | 100% | 95% | 100% |
| steel plate) | CF | CF | CF | CF | CF | CF |
| capaslagma | 100% | 100% | 100% | 0% | 100% | 100% |
| (Tin plate) | CF | CF | CF | CF | CF | CF |
| capaslagma | 0% | 0% | 0% | 0% | 70% | 100% |
| (RS14) | CF | CF | CF | CF | CF | CF |
| Bubble inside | NO | NO | NO | NO | NO | NO |
| | bubble | bubble | bubble | bubble | bubble | bubble |
| salt spray | NA | NA | 100CF | 100CF | NA | 100CF |
| (RS14) | | | | | | |
| salt spray | NA | NA | 100CF | 100CF | NA | 100CF |
| (Tinplate) | | | | | | |

Table 7 shows testing results of the moisture-curable polyurethane sealant compositions E10-E11 and CE9-CE12.

1. A one-component polyurethane sealant composition comprises:
a) an isocyanate terminated polyurethane prepolymer, NCO group content of the isocyanate-terminated polyurethane prepolymer being 1.8-4.0 wt. %, based on the total weight of the isocyanate terminated polyurethane prepolymer,
b) a crosslinker having a functionality of 3,
c) an effective amount of catalyst, and
d) a silane coupling agent, the mole ratio of the —Si—O-A group of the silane coupling agent to the NCO group of the isocyanate terminated polyurethane prepolymer being 40:100 to 120:100, the silane coupling agent being represented by the following formulas: 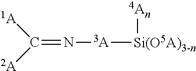
wherein, independently,
¹A, ²A, may be the same or different, and each is C1-C10, linear or branched, aliphatic or alicyclic or substituted alicyclic or aromatic hydrocarbons,
³A is a linear or branched, aliphatic or alicyclic or substituted alicyclic or aromatic divalent hydrocarbon residue having 1 to 20 carbon atoms,
⁴A, ⁵A, may be the same or different, and each representing a linear or branched alkyl group having 1 to 5 carbon atoms,
n is an integer of 0 to 2.

2. The composition according to claim 1, wherein the silane coupling agent being represented by the following formulas: 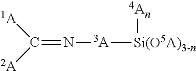
wherein, independently,
¹A, ²A each is C1-C6, linear or branched, aliphatic or alicyclic or substituted alicyclic or aromatic hydrocarbon group,
³A is a linear aliphatic alkylene having 2 to 6 carbon atoms,
⁴A, ⁵A each representing a linear or branched alkyl group having 1 to 3 carbon atoms,
n is an integer of 0 to 2.

3. The composition according to claim 1, wherein the silane coupling agent being represented by the following formulas: 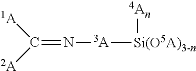
wherein, independently,
¹A, ²A each is C1-C6, linear or branched, aliphatic or alicyclic or substituted alicyclic or aromatic hydrocarbons,
³A is —CH₂—CH₂— or —CH₂—CH₂—CH₂—,
⁴A, ⁵A each representing methyl, ethyl or isopropyl,
n is an integer of 0 to 1.

4. The composition according to claim 1, wherein the NCO group content of the isocyanate-terminated polyurethane prepolymer is 2.0 to 3.5 wt. %, based on the total weight of the isocyanate terminated polyurethane prepolymer.

5. The composition according to claim 1, wherein the mole ratio of the —Si—O-A group of the silane coupling agent to the NCO group of the isocyanate terminated polyurethane prepolymer is 42:100 to 108:100.

6. The composition according to claim 1, wherein the content of the silane coupling agent is 1.3-2.7 parts by weight.

7. The composition according to claim 1, wherein the content of the silane coupling agent is 1.5-2.5 parts by weight.

8. The composition according to claim 1, wherein the composition comprises 10 to 60 parts by weight of isocyanate terminated polyurethane prepolymer.

9. The composition according to claim 1, wherein the catalyst is selected from a group consisting of platinum, palladium, rhodium, nickel, iridium, ruthenium catalyst, or mixtures thereof.

10. The composition according to claim 1, wherein the composition comprises 0.05 wt. % to 4.0 wt. % of a water-remover, based on the total weigh of the composition.

11. The composition according to claim 10, wherein the water-remover comprises reactive isocyanate, molecular sieve, calcium oxide, orthoformate or silicate.

12. The composition according to claim 1, wherein the composition further comprises 10 to 40 parts by weight of plasticizer.

13. The composition according to claim 1, wherein the composition further comprises 10 to 40 parts by weight of filler.

14. The composition according to claim 13, wherein the filler comprises calcium carbonate, carbon black, alumina, kaolin, PVC powder, silicate or hollow glass microspheres, mica powder, attapulgite or mixtures thereof.

15. An article comprising a sealant on a surface of the article, wherein the sealant is a cured product of the composition of claim 1.

16. A method of using a one-component polyurethane sealant which comprises:
applying a one-component polyurethane sealant composition of claim 1 on a surface of an article, and
curing the one-component polyurethane sealant composition in contact with the surface.
